(19) United States
(12) Patent Application Publication
(10) Pub. No.: US 2024/0375936 A1
(43) Pub. Date: Nov. 14, 2024

(54) RIDING AID APPARATUS AND METHOD OF MANUFACTURE THEREOF

(71) Applicants: Victoria Dennis, Yorkshire (GB); Ruth Schofield, Yorkshire (GB)

(72) Inventors: Victoria Dennis, Yorkshire (GB); Ruth Schofield, Yorkshire (GB)

(21) Appl. No.: 18/684,508

(22) PCT Filed: Aug. 17, 2022
(86) PCT No.: PCT/GB2022/052134

§ 371 Date: Feb. 16, 2024

(30) Foreign Application Priority Data
Aug. 17, 2021 (GB) 2111768.4

(51) Int. Cl. B68C 1/20; B68C 1/14

(52) U.S. Cl. CPC B68C 1/20; B68C 2001/142

(57) ABSTRACT

The present invention provides a riding aid apparatus, preferably an equine riding aid apparatus, which comprises an elongate member having first and second opposing ends, complementary connection means located at or associated with each of the first and second opposing ends to connect the same together via the connection means, in use, one or more pockets located within a body of the elongate member, intermediate the first and second opposing ends, and one or more inserts, each received respectively in the one or more pockets.

The invention to which this application relates is a riding aid apparatus and a method of manufacture thereof.

Equestrianism (horse riding) is carried out by people for a variety of purposes including work, transportation, recreation cultural exercises, and competitive sport. One of the most important aspects when a person is learning to ride a horse is their relationship with the horse, and more specifically, their posture and composure when riding the horse. Horses can be temperamental, and some are more challenging to ride than others. Generally, a horse will respond better to its rider if the rider maintains a good posture and remains relaxed in the saddle. If for example, the rider slouches, or has a bias to one (stronger) side, this can lead to the rider “collapsing” slightly to one side or the other, which in turn results in them bracing their thighs against the horse or its saddle in order to maintain their own shape. However, this can have a detrimental effect on the horse, as it is able to feel such tension or bracing, which has a restrictive effect on its body, increasing its stress levels and making it more challenging to ride and/or control properly. Bracing is one of the consequences of a rider being unbalanced in the saddle; when a rider is unlevel and unbalanced, and particularly when their bodyweight falls to the outside, the horse is physically unable to “connect” and is compromised by the rider's inability to maintain straightness and distribute their weight evenly in the saddle.

The vast majority of equine riding aids focus on the horse itself, rather than the rider, where the source of the problems may actually lie. One exception to this is the use of a “Franklin Ball”. One way these are used as aids is by providing a pair of them, with each one located under the arms (effectively in the armpits) of the rider, encouraging them to maintain a better upper body posture on the horse. The balls, however, are not fixed in place and can easily dislodge, and so a lot of the rider's concentration may on maintaining them in place, rather than on riding the horse properly. Furthermore, this riding aid does not necessarily protect against the rider collapsing to one side or another, and subsequently bracing their inner thighs against the horse or saddle, creating tension through the rider and horse. This tension, when transferred through to the horse, physically prevents them from extending their hind legs properly, which of course affects their movement and ability to turn exactly as desired.

It is therefore an aim of the present invention to provide an improved equine riding aid apparatus which overcomes the aforementioned problems associated with the prior art.

It is a further aim of the present invention to provide a method of manufacturing an equine riding aid apparatus which overcomes the aforementioned problems associated with the prior art.

According to a first aspect of the invention there is provided a riding aid apparatus, said apparatus including:
an elongate member having first and second opposing ends;
complementary connection means located at or associated with each of said first and second opposing ends to connect the same together via the connection means, in use;
one or more pockets located within a body of the elongate member, intermediate the first and second opposing ends; and
one or more inserts, each received respectively in the one or more pockets.

Typically, said apparatus is an equine riding aid apparatus.

In one embodiment, said one or more pockets extend substantially across a width of the elongate member, from a first side to a second, opposing side.

In a preferred embodiment, at least two pockets are provided with the elongate member, each for receipt of corresponding inserts.

Typically, said one or more inserts are provided as foam inserts. In one embodiment, the one or more inserts are formed from high density foam roll. Preferably, the one or more inserts are substantially cylindrical in shape.

Typically, the apparatus is arranged to be wearable by a user, in use. Preferably, the apparatus is worn by a user around the lower thigh portion, and said one or more inserts are arranged to locate adjacent the inner thigh of the wearer, in use.

The present invention therefore provides an improved equine riding aid which can be worn by a rider around their lower thigh(s). One or more pockets containing inserts-preferably at least two of said pockets—are located on the apparatus and when worn, the inserts are arranged to be located with the inner thigh of the wearer. This then creates a spacing effect between the rider's thigh(s) and the saddle or horse on which they are riding, serving to prevent bracing of the rider's thigh or thighs against the horse, which as discussed above can increase the stress level and inhibit movement of the hind legs of the horse. The apparatus therefore also has the effect of supporting the rider's upper body and encouraging a more correct posture, while also promoting straightness in the horse's body too.

Typically, said complementary connection means may be provided as a set of hook and loop fasteners (commonly referred to by the registered trade mark Velcro®). In one embodiment, said complementary hook and loop fastening portions are located at each of said first and second opposing ends of the elongate member.

In another embodiment, said connection means may be provided as one or more straps located at a first end of the elongate member, arranged to feed through one or more buckles or loops located at the second, opposing end, the one or more straps being attachable to themselves via the provision of hook and loop fastening portions located thereon.

In another embodiment, said complementary connection means may be provided as one or more straps located at a first end of the elongate member, and one or more complementary ladderlock buckles located with the second, opposing end.

In another embodiment, said complementary connection means may be provided as one or more side-release buckles, whereby complementary connectors of said side-release buckles are located at or with opposing ends of the elongate member. Typically, adjustable straps are provided associated with said side-release buckles. This, consequently, enables the apparatus to be fully functional and wearable by users with varying leg sizes.

In another embodiment, said complementary connection means may be provided as one or more belt strap-style buckles. Typically, such buckles are adjustable in length. Again, this enables the apparatus to be fully functional and wearable by users with varying leg sizes.

It will also be appreciated that in other embodiments of the present invention, other such appropriate buckles or connecting devices may be provided to ensure connection between the first and second opposing ends of the elongate member of the apparatus.

In one embodiment, the elongate member is formed from or at least includes an elastic material. Typically, said elongate member is provided as a heavy-stretch, high-elasticity band.

In one embodiment, forming the elongate member from an elastic material, or including an elastic material in the make-up of the elongate member, enables the same to stretch and extend to accommodate varying sizes of different users' legs. Further, the provision of an elastic and stretchable elongate member provides for a more comfortable and “snug” fit of the apparatus on the user.

Typically, the complementary connection means comprise complementary hook and loop fastening portions, each located at the respective first and second opposing ends of the elongate member, and across its width. This enables the apparatus to effectively stretch and wrap-around the thigh of the user such that the first end overlaps and attaches to the second opposing end (or vice versa) via the hook and loop fastening portions.

Preferably, the hook portion of the connection means, at the first end of the elongate member, is provided across the width of the elongate member on a first face thereof, and the loop portion of the connection means, at the second opposing end of the elongate member, is provided across the width of the elongate member on a second, opposing face thereof.

In another aspect of the present invention, there is provided a method of manufacturing a riding aid apparatus, said method including the steps of:

forming an elongate member having first and second opposing ends;

providing complementary connection means to be located at or associated with each of said first and second opposing ends, arranged to connect the same together via the connection means, in use;

forming one or more pockets within a body of the elongate member, intermediate the first and second opposing ends; and

providing one or more inserts, each to be received respectively in the one or more pockets.

Preferably, at least two pockets are formed within the elongate member, each for receipt of corresponding inserts.

Typically, said one or more inserts are formed from a foam material. Preferably, said one or more inserts are formed to be substantially cylindrical in shape.

In one embodiment, the elongate member is formed from or at least provided to include an elastic material. Typically, said elongate member is provided as a heavy-stretch, high-elasticity band.

Typically, the complementary connection means are formed as complementary hook and loop fastening portions, each to be located at the respective first and second opposing ends of the elongate member, and across its width.

Preferably, the hook portion of the connection means, located at the first end of the elongate member, is applied to the elongate member to extend across the width of the same on a first face thereof, and the loop portion of the connection means, located at the second opposing end of the elongate member, is applied to the elongate member to extend across the width of the same on a second, opposing face thereof.

In another aspect of the present invention, there is provided a method of using a riding aid apparatus as defined above, said method including the steps of:
taking riding aid apparatus as defined above and placing the same around the thigh of a wearer;
connecting the first end of the elongate member to the second, opposing end, via the complementary connection means provided therewith;
adjusting the apparatus and/or connection means such that the apparatus fits around the thigh, with little or no slack or movement of the apparatus up and down the thigh of the wearer;
adjusting the apparatus such that the one or more inserts are located against the inner thigh of the wearer.

Embodiments of the present invention will now be described with reference to the accompanying figures, wherein:

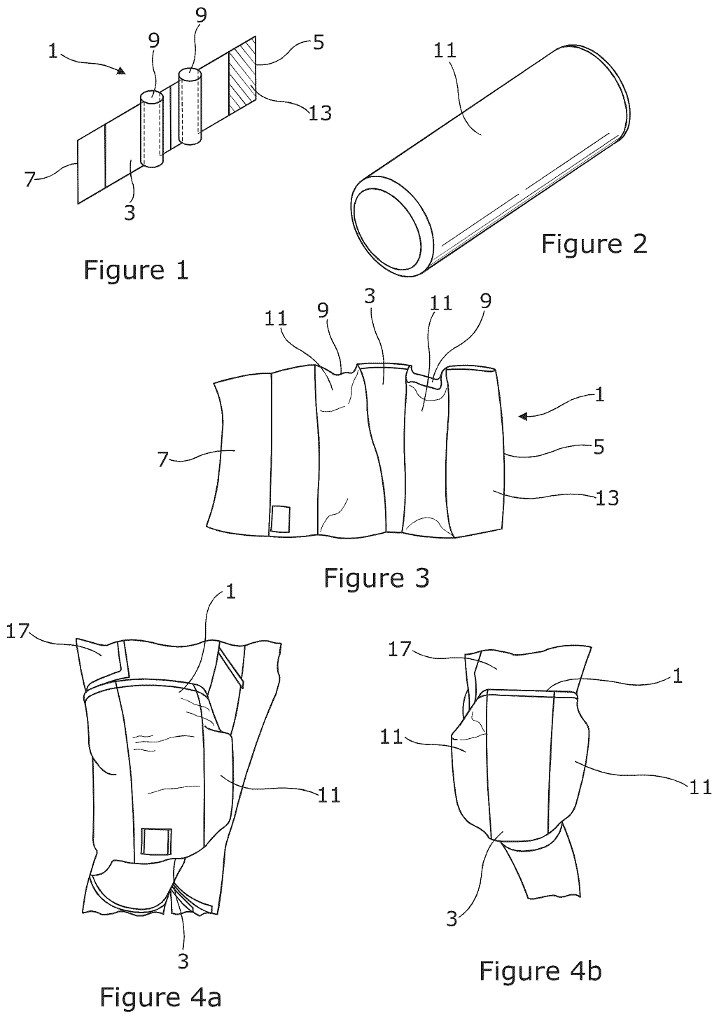

FIG. 1 illustrates a perspective view schematic of a riding aid apparatus, in accordance with an embodiment of the present invention;

FIG. 2 illustrates a perspective view schematic of an insert forming part of a riding aid apparatus, in accordance with an embodiment of the present invention;

FIG. 3 illustrates a front view of a riding aid apparatus, in accordance with an embodiment of the present invention;

FIGS. 4a-b illustrate a riding aid apparatus in accordance with an embodiment of the present invention being worn by a user from an outside leg perspective (a) and an inside leg perspective (b)

FIG. 5a-b illustrate the riding posture of a rider before (FIG. 5a) and after (FIG. 5b) a three-week period of use of a riding aid apparatus in accordance with an embodiment of the present invention;

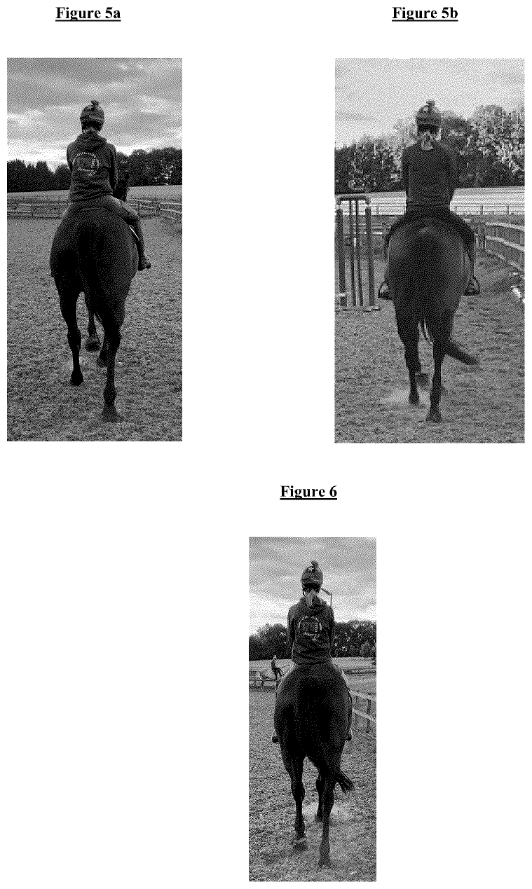

FIG. 6 illustrates the riding posture of a rider wearing a riding aid apparatus in accordance with an embodiment of the present invention;

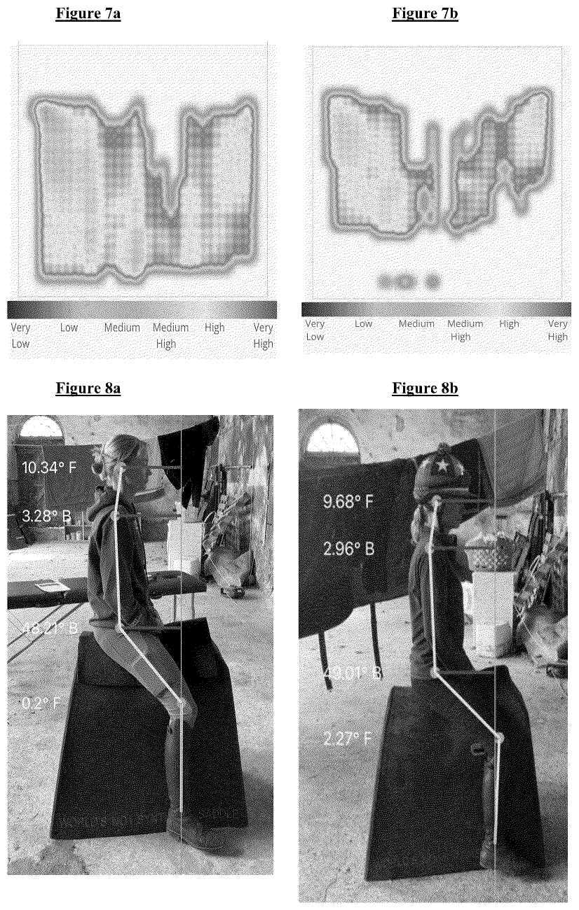

FIGS. 7a-b illustrate sensor mat images before (FIG. 7a) and after (FIG. 7b) a three-week period of use of a riding aid apparatus in accordance with an embodiment of the present invention;

FIGS. 8a-b illustrate side-on views of a rider before (FIG. 8a) and after (FIG. 8b) a three-week period of use of a riding aid apparatus in accordance with an embodiment of the present invention; and

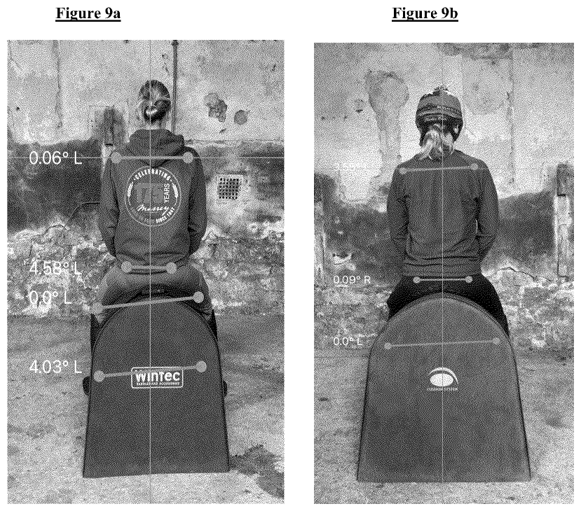

FIGS. 9a-b illustrate rear views of a rider before (FIG. 9a) and after (FIG. 9b) a three-week period of use of a riding aid apparatus in accordance with an embodiment of the present invention.

Referring now to the Figures, there is provided a riding aid apparatus 1 shown schematically in FIG. 1. The apparatus 1 comprises an elongate body portion 3 extending between a first end 5 and a second opposing end 7. Located in the body portion between the two ends are one or more pockets 9. In a preferred embodiment, illustrated, two pockets 9 are provided, although it will be appreciated more or fewer pockets 9 may be provided as required. The pockets 9 are provided to extend substantially across a width of the body portion 3, from a first side to a second opposing side. The pockets are formed so as to each receive an insert 11, illustrated in FIG. 2. The inserts 11 are formed generally from a foam material, preferably high density foam roll. In order to best fit the pockets 9, and also to provide the greatest comfort to the wearer of the riding aid 1, the inserts 11 are formed in a substantially cylindrical shape. This is most beneficial as it means there are no clear edges which may press or dig into the wearer, in use, causing discomfort.

Located at or associated with each of the ends 5, 7 there are provided complementary connection means, provided to connect the respective ends 5, 7 of the body portion 3 together as it wraps around a user's leg, in use. The present invention therefore provides riding aid 1 which can be worn by a rider around their lower thigh-two such aids 1 may be provided such that the rider has one on each thigh, if required. One or more pockets 9 containing inserts 11—in preferred embodiments two such pockets 9 and associated inserts 11 are provided—are located on with the aid 1 and when worn, the inserts 11 are arranged to be located with the inner thigh of the wearer. The inserts 11 thus act as spacers, creating the spacing effect between the rider's thigh and the saddle or horse on which they are riding, serving to prevent bracing of the rider's thigh or thighs against the horse, which as discussed above can increase the stress level and inhibit movement of the hind legs of the horse. The aid 1 also has the effect of supporting the rider's upper body and encouraging a more correct posture, while also promoting straightness in the horse's body too.

As mentioned above, complementary connection means are provided at or associated with the respective ends 5, 7 of the body portion 3. In a preferred embodiment of the invention, the connection is formed via the provision of complementary hook and loop fastening (commonly referred to by the registered trade mark Velcro®) portions. A first “hook” portion 13 may be provided to be located at the first end 5 of the body 3 on a first face thereof. For strength and maximum adherence, the portion 13 is provided to locate across the width of the body 3, as shown in FIGS. 1 and 3. A second “loop” portion 15 is then provided to be located at the second end 7 of the body 3 on the reverse face of the body 3. Again, for strength and maximum adherence, the portion 15 is provided to locate across the width of the body 3.

As an alternative to the preferred form of the connection means, they may also be provided in a variety of other forms. For example, they may be provided as one or more straps located at the first end 5, arranged to feed through one or more buckles or loops located at the second end 7 as the aid 1 is wrapped around a user's thigh, the one or more straps being attachable to themselves via the provision of hook and loop fastening portions located along those straps. In another example, the connecting portions may be provided as one or more straps located at the first end 5, and one or more complementary ladderlock buckles located with the second end 7. The connecting portions may be provided as one or more side-release buckles, whereby complementary connectors of the side-release buckles can be located at or with the first and second ends 5, 7 of the body 3. Adjustable straps can then be provided with said side-release buckles, which consequently enables the aid 1 to be fully functional and wearable by users with varying leg sizes. In another example, the connecting portions may be provided as one or more belt strap-style buckles, which again enables them to be adjustable in length. Other such connecting means may also be employed.

In a preferred form, the body portion 3 of the aid 1 is formed from or at least includes an elastic material. Typically, it is forms from a heavy-stretch, high-elasticity band. By forming the body 3 from an elastic material, or incorporating an elastic material therein, this enables the body 3 to stretch and extend to accommodate varying sizes of different users' legs.

Furthermore, this also provides for a more comfortable and “snug” fit of the aid 1 on the user. When the body 3 is elasticated in such a manner, and the connecting portions are provided as complementary hook and loop fastening portions 13, 15 as shown in FIGS. 1 and 3, the aid 1 may then effectively stretch and wrap-around the thigh of the user such that the first end 5 overlaps and attaches to the second end 7 (or vice versa) via the hook and loop fastening portions 13, 15, creating a secure connection and a snug fit, and one which equally, is easily removable.

Once attached to and wrapped around a wearer's thigh 17, the aid 1 may then be adjusted such that it is positioned at the correct height on the user's leg, and then rotated into the optimum position, such that the inserts 11 are located adjacent the user's inner thigh—this is the region that would ordinarily contact the saddle or body of the horse if and when the user braces when riding. This is illustrated in FIG. 4a, which shows a view looking at the outer leg-one insert 11 at the front inner thigh is visible. In FIG. 4b, this illustrates the perspective looking at the inner leg-two inserts 11 in this instance are visible, located at the front inner thigh (as per the view in FIG. 4a) and also at the rear inner thigh. The inserts 11, located in the pockets 9, maintain the gap between the thigh and the saddle or body of the horse, encouraging the user to maintain a correct posture while also preventing their thighs from inhibiting the movement of the horse and causing further distress to the horse.

In-house studies of the effectiveness of the riding aid 1 of the present invention were carried out over a three-week period, with the rider's posture assessed by a physiotherapist before and after use of the aid 1. The difference in riding posture of the rider is illustrated most starkly in FIGS. 5a-b, wherein FIG. 5a illustrates the riding posture prior to any use of the aid 1. Quite clearly in this image, the rider has a number of issues in technique and posture, namely: the left hip “falling out”; rotating right at the trunk, ribs and shoulders; a protracted posture; the shoulders are shifted left; the left shoulder is elevated; the left hand is crossing wither; the left knee too far forward; and there is over activity associated with the right obliques. This is contrasted with FIG. 5b, illustrating the rider's posture, without the aid 1, but after 3 weeks of use of the aid 1. In this image, it can be seen that there has been a marked improvement, although with still a slight protracted posture and over activity in the right obliques. The entire trunk is more balanced, and the shoulders have been rotated right.

FIG. 6 illustrates the same rider on the first day of the study, however, now wearing the riding aid 1 of the present invention
immediately, an improvement in the riding posture can be seen: the posture is more central through the pelvis, ribs and shoulders; the knees are level; the rider is more level through the shoulders; more equal pressure through seat; reduced left hand position; and reduced trunk rotation.

Consequently, there are some immediate visible benefits of using the aid 1 of the invention, those being: a reduced ability to fix through the more overactive right leg; an improved positioning of the right leg; improved left glute med and therefore pelvic stability laterally on the left, resulting in an improved position of the pelvis in the saddle; and some reduction of over activity through right trunk. Over the course of a three-week period using the aid 1, the improvements become more apparent and enable the rider to begin to ride, without use of the aid 1 but with a much-improved posture. The aid has successfully helped to improve left glute med strength of the rider; improve left pelvic stability in saddle; improve symmetry in saddle; reduce over activity through right leg; improve pelvic ranges; improve hand position; and reduce compensatory fixings through opposite muscle groups.

FIGS. 7a-b illustrate sensor mat images of the rider on day one of the study (FIG. 7a), and again after the three-week period of use with the aid 1 (FIG. 7b). FIG. 7a highlights the increased pressure applied through the left seat and thigh and reduced contact through the right seat bone. After three weeks of use of the aid 1 of the invention, FIG. 7b highlights a reduced grip through the left thigh and buttock, and a reduction in contact through the right buttock and thigh, leading to a better posture. FIGS. 8a-b illustrate side-on images of the rider before (FIG. 8a) and after (FIG. 8b) the study, and FIGS. 9a-b illustrate rear views of the rider before (FIG. 9a) and after (FIG. 9b) the study, the improvement being clearly visible.

In summary, use of the riding aid apparatus 1 of the present invention, over a period of three weeks, has been shown quite clearly to result in:
A much-improved pelvic position, no longer rotating or falling out through the left side of the pelvis;
The shoulders are now level in sitting and not rotated;
There are no changes to hip ranges;
The rider is now stronger on the left side of their pelvis;
An improved posture/lumbar lordosis; and.
The ribs are now central over pelvis with only a mild rotation.

The present invention thus provides a novel equine riding aid 1 to be worn by the rider of a horse, which serves to correct posture and relieve the stress and pressures of bracing of thighs against the saddle or body of a horse, which otherwise would inhibit movement of the hind legs of the horse, and create additional tension between horse and rider.

1. A riding aid apparatus, said apparatus including:
an elongate member having first and second opposing ends;
complementary connection means located at or associated with each of said first and second opposing ends to connect the same together via the connection means, in use;
one or more pockets located within a body of the elongate member, intermediate the first and second opposing ends; and
one or more inserts, each received respectively in the one or more pockets.

2. An apparatus according to claim 1, wherein said apparatus is an equine riding aid apparatus.

3. An apparatus according to claim 1, wherein said one or more pockets extend substantially across a width of the elongate member, from a first side to a second, opposing side.

4. An apparatus according to claim 1, wherein at least two pockets are provided with the elongate member, each for receipt of corresponding inserts.

5. An apparatus according to claim 1, wherein said one or more inserts are provided as foam inserts.

6. An apparatus according to claim 1, wherein the one or more inserts are substantially cylindrical in shape.

7. An apparatus according to claim 1, wherein the apparatus is arranged to be wearable by a user around the lower thigh portion, and said one or more inserts are arranged to locate adjacent the inner thigh of the wearer, in use.

8. An apparatus according to claim 1, wherein said complementary connection means are provided as a set of hook and loop fasteners, located at each of said first and second opposing ends of the elongate member.

9. An apparatus according to claim 1, wherein said connection means are provided as one or more straps located at a first end of the elongate member, arranged to feed through one or more buckles or loops located at the second, opposing end, the one or more straps being attachable to themselves via the provision of hook and loop fastening portions located thereon.

10. An apparatus according to claim 1, wherein said complementary connection means are provided as one or more straps located at a first end of the elongate member, and one or more complementary ladderlock buckles located with the second, opposing end.

11. An apparatus according to claim 1, wherein said complementary connection means are provided as one or more side-release buckles, whereby complementary connectors of said side-release buckles are located at or with opposing ends of the elongate member.

12. An apparatus according to claim 1, wherein said complementary connection means are provided as one or more belt strap-style buckles.

13. An apparatus according to claim 1, wherein the elongate member is formed from or at least includes an elastic material.

14. A method of manufacturing a riding aid apparatus, said method including the steps of:
forming an elongate member having first and second opposing ends;
providing complementary connection means to be located at or associated with each of said first and second opposing ends, arranged to connect the same together via the connection means, in use;
forming one or more pockets within a body of the elongate member, intermediate the first and second opposing ends; and
providing one or more inserts, each to be received respectively in the one or more pockets.

15. A method according to claim 14, wherein at least two pockets are formed within the elongate member, each for receipt of corresponding inserts.

16. A method according to claim 14, wherein said one or more inserts are formed from a foam material.

17. A method according to claim 14, wherein said one or more inserts are formed to be substantially cylindrical in shape.

18. A method according to claim 14, wherein the elongate member is formed from or at least provided to include an elastic material.

19. A method according to claim 14, wherein the complementary connection means are formed as complementary hook and loop fastening portions, each to be located at the respective first and second opposing ends of the elongate member, and across its width.

20. A method of using a riding aid apparatus as defined above, said method including the steps of:
taking riding aid apparatus as defined above and placing the same around the thigh of a wearer;
connecting the first end of the elongate member to the second, opposing end, via the complementary connection means provided therewith;
adjusting the apparatus and/or connection means such that the apparatus fits around the thigh, with little or no slack or movement of the apparatus up and down the thigh of the wearer;
adjusting the apparatus such that the one or more inserts are located against the inner thigh of the wearer.
